(19) United States
(12) Patent Application Publication
(10) Pub. No.: US 2025/0236189 A1
(43) Pub. Date: Jul. 24, 2025

(54) SUPPLY SYSTEM FOR AN ELECTRICAL LINE, IN PARTICULAR FOR A CHARGING CABLE FOR AN ELECTRIC VEHICLE

(71) Applicant: IGUS GMBH, Köln (DE)

(72) Inventors: Thilo-Alexander JAEKER, Sankt Augustin (DE); Christoph KOCH, Grafschaft (DE)

(21) Appl. No.: 18/853,452

(22) PCT Filed: Feb. 1, 2023
(86) PCT No.: PCT/EP2023/052489

§ 371 Date: Oct. 2, 2024

(30) Foreign Application Priority Data
Apr. 7, 2022 (DE) 20 2022 101 895.2
Apr. 25, 2022 (DE) 10 2022 109 915.6

(51) Int. Cl. B60L 53/18; H02G 11/02

(52) U.S. Cl. CPC B60L 53/18; H02G 11/02

(57) ABSTRACT

A supply system for cables for charging electric vehicles, wherein a cable store comprises a plurality of pulleys which are arranged in at least two pulley blocks such that a cable can be threaded in multiple windings. One pulley block is linearly guided relative to the other on a moveable pulley block carrier and can be adjusted against a restoring force. The pulley blocks are mounted on one side and in a cantilevered manner and/or can be adjusted against the force of a deflected flexible spring element and/or each have multiple pulleys distributed in an arc-shape over a circular arc.

### FIELD

The invention relates to a supply system with a return function or return device for a line, in particular electrical lines or cables, in particular for cables for charging electric vehicles, comprising at least one cable store, wherein the cable store comprises a plurality of pulleys, which are arranged in at least two pulley blocks such that a cable can be reeved into the pulley blocks in multiple windings, wherein a first pulley block and a second pulley block are adjustable or displaceable relative to each other, at least one of the first and second pulley blocks is arranged on a linearly guided, displaceable pulley block carrier, and the first and the second pulley block are movable towards each other against a restoring force.

### BACKGROUND

A supply system of the type described above is known for example from EP 3 271 983 B1. This published document describes an electrical connection system for charging a battery of a motor vehicle having a storage device for an electric cable comprising at least three pulleys, which are distributed in two rows, as well as a chain of spring elements, which are connected to the lower row and exert a holding force which increases with the length of the cable and a restoring force which decreases with the storage of the cable, wherein coil springs with different stiffnesses arranged in a row are provided as spring elements. This arrangement is to guarantee that an increasing holding force is generated as the cable is increasingly unwound and a decreasing restoring force is exerted as the cable is returned.

Further state of the art is known for example from JP 2014230298 A, which comprises a cable supply system with a cable store, in which pulleys are arranged in two pulley blocks, from which the cable can be unwound under tension, wherein both pulley blocks are resiliently mounted and in each case are displaceable against each other against the force of a tension spring. Another cable supply system is known from EP 2 813 455 A1, but this is primarily designed for network cables with a small cross section. It is intended to allow a simple installation or replacement of the cable but is not very suitable for cables for charging electric vehicles.

Other supply systems are known for example from the publications US 2017/203662A1, EP 2 813 455A1, EP 3 350 108B1, DE 10 2019 104 131A1, GB 2 574 735A, US 2013/068870A1 and DE 10 2012 02332A1.

The known supply systems are formed such that they must be provided to the user completely ready for use with the corresponding cable. Any required replacement or a repair of the electrical lines or of the cable is not taken into account in the design of the known systems. Depending on the charging technology and provision of mains connections or mains connection points, it may be necessary to provide the supply system with electrical lines which are designed for different voltages and/or different currents. This requires that cables with different line cross sections be laid. In addition, depending on the installation location, there are different electrical safety requirements or different connectors must be provided. Therefore, it is in principle desirable that the user can easily lay electrical lines or cables themselves.

### SUMMARY

A first partial object of the present invention relates to the provision of a supply system for electrical lines which is formed particularly simple and user-friendly with respect to maintenance and repair as well as with respect to being ready to use.

Charging the batteries of a motor vehicle is generally effected by connecting a battery charging device provided in the vehicle to a voltage source, for example on a charging column, which is connected to a mains supply. When the motor vehicle is not being charged, it is generally desirable for the charging cable to be stowed. The previously described cable stores provide the possibility of stowing several metres of a charging cable wound up on pulleys arranged to form pulley blocks, wherein the cable is arranged in multiple windings, which are reeved into the pulley blocks in the manner of a block and tackle. Supplying the free end of the cable, which is generally provided with a corresponding charging plug, to the charging port or socket of the motor vehicle is effected by exerting tension on the free end of the cable while partially pulling the cable out of the cable store. The amount by which the cable is pulled out corresponds to a multiple of the length of the individual threads or the individual portions of the cable between the pulleys of the pulley blocks. In this way, it is possible to provide a compact cable store out of which cable can be pulled with relatively little force. Since the tensile force required is inversely proportional to the number of threads, it is guaranteed that the user can pull the cable out of the cable store with as little force as possible.

On the other hand, while the cable is being unwound a particular restoring force is to be generated so that the cable can be retracted again automatically during stowing. In order to guarantee this, in the state of the art it is known to apply the restoring force by means of weights and/or spring elements. In particular, the solution according to EP 3 271 983 B1 is based on exerting a holding force which increases with the length of the cable and a restoring force which decreases with the return of the cable, wherein this is accomplished by springs with different stiffnesses connected in series or arranged in rows. However, such an arrangement has the disadvantage that it requires a relatively large amount of installation space inside the housing, in particular a large installation height.

US 2017/0203662 A1 describes a further retraction system in a charging station for cables for charging electric vehicles, which does not allow simplified replacement of the charging cable, however.

The invention is therefore furthermore based on the partial object of providing a supply system of the type mentioned at the beginning which for one thing is constructed relatively compactly and for another provides the greatest possible ease of use to the user.

Such systems with pulleys arranged distributed in an arc shape have generally already been proposed in GB2574735A and in DE 10 2019 104 131 A1. However, such systems have not yet become established for charging cables of electric vehicles, and some are not suitable for this. Compared with these, the susceptibility to faults is to be reduced and the reliability of the supply system improved.

Advantageous designs of the invention follow in each case from the dependent claims, which can in principle also be combined with each other for all aspects and are also to be understood as disclosed within the framework of the invention in combination.

### First Aspect (Mounting on One Side)

A first aspect of the invention relates to a supply system with a retracting function or retracting device for lines, in particular for cables for charging electric vehicles, comprising at least one cable store, wherein the cable store comprises a plurality of pulleys, which are arranged in at least two pulley blocks such that a cable can be reeved into the pulley blocks in multiple windings, wherein a first pulley block and a second pulley block are movable or displaceable relative to each other, at least one of the first and second pulley blocks is arranged on a linearly guided, displaceable pulley block carrier, and the first and the second pulley block are movable towards each other against a restoring force, wherein the supply system according to the first aspect of the invention is characterized among other things in that the pulley blocks each have an axle which is mounted or attached or is supported on one side and cantilevered.

The first pulley block is preferably arranged fixed in position, preferably inside a housing. In such a case it is advantageous if the second pulley block is displaceable with respect to the first pulley block on the pulley block carrier, e.g. is mounted relatively movable. The pulley block carrier can for example be formed as a carriage guided by means of rollers or slide bearings. It is sufficient in principle if only the second pulley block is relatively movable, which simplifies the design.

The fact that the pulley blocks each have an axle which is mounted on one side and cantilevered is especially advantageous in particular because the pulley blocks are thus accessible on one side in such a way that a cable can be laid from one side without having to be threaded through awkwardly, as would otherwise be the case in closed pulley blocks. Owing to this design, the first pulley block can for example be fastened to a wall on one side, whereas the second pulley block can be mounted on an axle fastened on one side and cantilevered on a pulley block carrier preferably formed as a carriage. In this way, it is possible both to lay the cable on one side and to push individual pulley wheels or pulleys onto the axle. The pulleys or the pulley wheels can likewise be mounted with ball bearings or slide bearings, wherein polymer bearings can also be provided for this purpose.

In the present case “mounted cantilevered” means mounted or held in particular only on one side with a self-supporting opposite region, for instance in the sense of a cantilever beam. As a result of this, the pulley blocks are easily accessible from the free side since no fastening or the like needs to be released here.

By the term “to thread into” or “to reeve”, or “can be reeved”, is meant, in relation to the pulley blocks, an arrangement in which the cable is laid or inserted, or can be laid or inserted, on or in the pulley blocks in multiple windings, similarly to the case of a block and tackle, or just tackle.

According to an embodiment example of the invention, the pulley blocks can be arranged in a housing, for example. In such a configuration, the pulley block carrier can be displaceably guided inside the housing. It is advantageous if the housing has at least one guide profile, preferably multiple guide profiles, for guiding the pulley block carrier. It is particularly preferably provided that the housing comprises two face profiles, which are preferably formed as feet and which each form a guide profile for the pulley block carrier.

In an embodiment, the housing can accommodate electrotechnical devices and/or component parts for charging electric vehicles and, for this, can have, for example, a separate and/or sealed accommodating area or a separate and/or sealed compartment, preferably with a suitable IP class.

In a variant, the pulley block carrier can have a C- or U-shaped cross-sectional profile, which is open in the direction of the extent of an axle, with the result that the pulley block or the pulley wheels are easily accessible from one side in any case. The pulley block carrier can be formed as a plastic profile which has two faces, each forming a lateral side piece of the pulley block carrier, on which guide rollers can be arranged, for example.

The axles can each accommodate a plurality of individual pulleys mounted rotatable independently of each other, which can, for example, consist of identically formed pulley wheels, which are each formed as injection-moulded plastic parts.

It is particularly expedient and advantageous if the housing has housing parts which can be removed by a user and which are formed such that the user can lay the connected charging cable with a connected charging plug on the pulleys when the housing is open. This guarantees that the supply system according to the invention can for example be retrofitted in domestic installations without the user needing to interfere with live parts of the charging station.

The housing can have at least one cable entry and at least one cable exit, which are formed such that the user can lay a cable, connected at least on one side and provided with a charging plug, on the pulleys without removing the charging plug or plugs from the cable.

In this connection it is advantageous and expedient if the housing can be opened by the user with simple handles. In the case of such a configuration of the housing, it makes sense for the cable to have an anti-theft device and/or a pull-out prevention device.

Therefore, in an advantageous variant of the supply system according to the invention at least one pull-out and removal prevention device, which comprises for example a cable guide with at least one electrically actuatable locking mechanism, is provided for at least one cable.

The cable guide can comprise a cable duct, for example, in which a cable can be fixed by means of a clamping shoe. The clamping shoe can be actuatable, for example by means of a servomotor, via a spindle drive which is arranged on the output shaft of the servomotor.

According to a further advantageous embodiment example of the invention it is provided that the pulley block carrier is guided in at least one guide profile which is arranged preferably centrally and furthermore preferably vertically in the installed position and which is formed as a guide frame or guide rail. This embodiment of the supply system according to the invention has the advantage that a housing is not necessary for the functionality of the system.

The supply system according to this embodiment can comprise a guide rail for wall mounting, wherein a pulley block can be fastened to the guide rail fixed in position, whereas the other pulley block can be arranged displaceable on and with the pulley block carrier in the guide rail.

The guide rail can alternatively be formed in the shape of a guide frame with a foot, with the result that the supply system can be installed freestanding.

Finally, the guide rail can furthermore additionally be arranged inside a housing, wherein in this case the housing is not necessary for the functionality of the supply system but only provides a protective function and possibly an anti-theft protection.

The guide rail can for example be formed as a C profile or a U profile. Alternatively, the guide rail can comprise one or more guide bars formed T-shaped or I-shaped, around which a contour of the pulley block carrier formed compatible can grip.

### Second Aspect (Retracting Spring System)

A subject-matter of the invention furthermore claimed individually as capable of being protected relates to a supply system with a retracting or return function for lines, in particular for cables for charging electric vehicles, comprising at least one cable store, wherein the cable store comprises a plurality of pulleys, which are arranged in at least two pulley blocks such that a cable can be reeved into the pulley blocks in multiple windings, wherein a first pulley block and a second pulley block are displaceable relative to each other, at least one of the first and second pulley blocks is arranged on a linearly guided, displaceable pulley block carrier, and the first and the second pulley block are movable towards each other against a restoring force, wherein the supply system is characterized in that the restoring force is generated by means of at least one elongate spring element, which acts on the second pulley block and extends in at least two portions over at least one deflection point fixed in position. This supply system according to the second aspect can furthermore have one or more of the features described in connection with the first aspect or further aspects of the invention.

In particular, the feature according to the invention that the elongate spring element is guided over at least one deflection point makes it possible to use a relatively thin and long, in particular flexible, spring element, which has a small spring constant. Because of this there is a slow increase in the restoring force as the pulled-out length of the cable increases. If the spring element has an approximately linear spring characteristic, a flat spring characteristic can be realized over the whole pulled-out length, with the result that, when pulling the cable out, the user has the feeling of applying a substantially constant tensile force. In fact, the tensile force when the cable is pulled out will increase over the pulled-out length. However, in the case of only a relatively small increase in the spring characteristic, the user subjectively has the feeling that the tensile force to be applied is constant over the whole pulled-out distance. In this way, a high level of ease of use is provided to the user.

A multiple deflection over at least two deflection points is particularly preferred, with the result that a spring element dimensioned particularly long with multiple portions along the guide direction or movement direction of the moving pulley block can be housed without increasing the size of the installation space.

In particular, a flexible, cordlike spring element, which is normally elastically stretchable, preferably in the manner of a rubber cord, rubber band, expander cord or the like, comes into consideration as spring element. Suitable coil springs also lie within the framework of the invention, albeit less preferably.

It is advantageously provided that the elongate spring element extends in at least two approximately parallel portions, preferably inside the housing. A relatively long spring element can thus be housed inside the housing without a significant increase in the installation space.

In a preferred and advantageous variant of the supply system according to the invention it is provided that the spring force is generated by means of at least one spring-elastic cord, which is placed in at least one loop over at least one deflection roller and is provided as spring element. Such a flexible cord, or expander cord, can be particularly beneficially fastened e.g. to side parts of the housing or in a guide rail between profile bars of the guide rail.

Alternatively, such an expander cord can be guided over one or more deflection rollers, which are fastened to a central guide rail. A housing is not strictly necessary for the functionality of the supply system in this variant of the supply system either.

Through one or more deflection rollers, it is possible to place the spring element or expander cord in multiple portions, which can preferably extend parallel to each other. Within the framework of the invention, in principle a single elongate spring element can be provided, which is guided over a plurality of deflection rollers, for example in the shape of a parallelogram.

However, the spring force is preferably generated by means of two elongate spring elements, which act on two sides of the second pulley block for the sake of introducing force symmetrically.

A rubbery-elastic cord, in particular an expander cord, or also a helical extension spring with a relatively small wire thickness, can be provided as spring element. A non-metallic spring element in the form of a rubbery-elastic and flexible cord is preferably provided as spring element. This can, for example, have a core or a centre made of a thermoplastic elastomer.

In an expedient variant of the supply system according to the invention it is provided that the spring force is generated by means of two spring elements and that one spring element is attached in each case to one of two sides of the pulley block carrier, with the result that the introduction of force into the pulley block carrier through the spring elements is symmetrical.

In each case, a free end of the spring element is preferably fastened to a guide profile, a guide rail or to a housing part, whereas the other end of the spring element is fastened in each case to a side of the pulley block carrier, for example by means of a fastening clamp.

Each of the spring elements is preferably guided over at least one upper and one lower deflection roller.

The at least one deflection roller or both deflection rollers can, for example, be mounted on the insides of the housing and/or be arranged fixed in position on the housing or on a guide profile or a guide frame.

### Third Aspect (Guided Arc Blocks)

A subject-matter of the invention furthermore claimed individually as capable of being protected relates to a supply system for an electrical line, e.g. a cable for charging electric vehicles, comprising at least one cable store which comprises a plurality of pulleys, which are arranged in at least two pulley blocks such that a cable can be laid in or introduced or reeved into the pulley blocks in multiple windings, wherein a first pulley block and a second pulley block are displaceable relative to each other, e.g. moveably mounted, and movable towards each other against a restoring force, similar to what was explained above.

Here, however, at least one of the two pulley blocks, in particular each of the two pulley blocks, now has in each case multiple pulleys or cable guide rollers arranged distributed in an arc shape over a circular arc around a deflection axis.

Here, each pulley block is preferably also implemented such that the cable can be reeved into the pulley blocks in multiple windings or can be laid thereon in multiple, offset windings. Each pulley block has pulleys which are preferably arranged and/or dimensioned such that they guarantee a minimum deflection radius, at the curved regions of the windings, which is preferably at least 800 mm, in particular at least 100 mm, with the result that undesired kinking load on the cores or conductors is minimized.

According to the third aspect of the invention, it is proposed that at least one of the first and second pulley blocks is arranged and held on a linearly guided, displaceable pulley block carrier. A stable guidance when the cable is pulled out and retracted, and additionally an easier installation, is thus achieved in comparison with known solutions. Here, according to the third aspect of the invention, of the two pulley blocks, at least the one that has multiple pulleys arranged distributed in an arc shape over a circular arc around a deflection axis is held on or carried by the linearly guided pulley block carrier according to the invention.

A particular advantage of pulleys distributed in an arc shape is that in the fully extended state the two pulley blocks can thus be moved much closer or very close to each other in an approximately semicircular shape or semidiscoid shape or similar. In comparison with complete pulleys in the manner of sheaves, this reduces the unused or “dead” length of line remaining in the cable store, with the result that a shorter charging cable can be used with the pulled-out length remaining the same, or a longer pulled-out length is achieved.

Within the framework of the invention, a typical single-axle pulley arrangement on the first pulley block and pulleys distributed in an arc shape only on the second pulley block is also conceivable, wherein the first pulley block, at least with a part of the pulley circumference of the coaxial pulleys, can then engage in the second pulley block.

However, pulleys distributed in an arc shape on both pulley blocks are particularly preferred, thus largely identical pulley blocks can be displaced towards each other in an arrangement rotated by 180° and at the same time a relatively large cable guide radius is ensured.

Thus, the pulleys are preferably distributed in an arc shape in each of the two pulley blocks, in particular distributed over a circular arc. The arc measure thereof is advantageously ≤180°, with the result that the two pulley blocks form an approximately circular store together only when in the fully extended state, i.e. at a minimum distance from each other. The arc measure is preferably at least 90°, preferably ≥120°, depending on the pulley diameter. The radius of the circular arc on which the pulley axles are distributed is preferably, for electric car charging cables, at least 50 mm, preferably at least 75 mm, particularly at least 100 mm.

In each pulley block—depending on the pulley diameter—at least four pulley groups arranged distributed are preferably provided, each preferably with at least one pulley, in particular at least three, which are preferably uniformly distributed around the circumference (distributed with equal arc spacing).

Each of the two pulley blocks advantageously, in design terms, has a substantially semicircular frame, with axles distributed over the circular arc, and two axially opposite carrier elements on which the axles are held.

In order to reduce or to minimize the offset of the cable during the transition from one pulley block to the other, it is advantageously provided that successive pulleys in the arc direction are mounted axially offset with respect to each other, e.g. through an offset of a few millimetres of the axles on the frame or of the individual pulley mountings on the respective axle.

Each pulley block preferably has securing bars which are arranged on the outside compared with the distributed pulleys. They can act against a radial releasing of the cable from the respective pulley block. The securing bars are preferably releasably attached to the frame, in particular so as to be able to fold out, in order to facilitate the installation or the subsequent replacement of the cable.

The securing bars can thus form a type of pulley cage with the frame for securely holding the cable on the respective pulley block.

In the third aspect, the first pulley block is preferably also arranged fixed in position and the second pulley block is displaceable with respect to the first pulley block on a linearly guided or movable pulley block carrier. Here, the pulley block carrier is particularly preferably guided on or in at least one guide profile, which is preferably arranged centrally and formed as a guide frame or guide rail.

In a preferred combination with the first aspect, the second pulley block is mounted on one side and cantilevered, in particular on the pulley block carrier. The first pulley block is correspondingly advantageously also fastened on one side and cantilevered, in particular to a housing or a guide rail of the pulley block carrier.

The supply system according to the third aspect can furthermore have one or more features which are described in connection with the further aspects of the invention disclosed herein.

### Further Aspect (Gas Spring)

A further aspect of the invention that is also regarded individually as capable of being protected but is purely optional relates to a supply system for lines, in particular for cables for charging electric vehicles, comprising at least one cable store, wherein the cable store comprises a plurality of pulleys, which are arranged in at least two pulley blocks such that a cable can be reeved into the pulley blocks in multiple windings, wherein a first pulley block and a second pulley block are displaceable relative to each other, at least one of the first and second pulley blocks is arranged on a linearly guided, displaceable pulley block carrier, and the first and the second pulley block are movable towards each other against a restoring force. This independent aspect of the invention or of the supply system is characterized in that the restoring force is at least partially generated by means of at least one gas spring, which acts on the second pulley block.

The supply system according to this further aspect of the invention can moreover also comprise one or more of the features described above or below as particularly advantageous. As an alternative or in addition to the above-described solution with a deflected spring element, a gas spring can be provided.

By a gas spring within the meaning of the present invention is meant a spring element which comprises a cylinder with a pressurized gas and a piston rod, wherein the guiding end of the piston rod can have a piston or is formed as a piston, which dips into the cylinder and is supported in a sliding manner against the cylinder wall via at least one sealant and in the process compresses and/or squeezes the gas contained in the cylinder.

In contrast to traditional mechanical springs, even in the case of a very long stroke gas springs have a flat spring characteristic which, in design terms, can for example be set particularly easily by corresponding openings and/or valves inside the piston or inside the piston rod. Furthermore, a damping effect which is easily settable in design terms and which brings about a damped and/or retarded retracting movement when the tension on the cable abates, and thus reliably prevents the cable end from accelerating when it is returned to the cable store, can also be achieved with a gas spring.

Because of the formation of the supply system according to the invention there is a slow increase in the restoring force as the pulled-out length of the cable increases, and a damped retracting movement. According to the invention, with a gas spring as spring element a flat spring characteristic can be realized over the whole pulled-out length, with the result that, when pulling the cable out, the user has the feeling of applying a substantially constant tensile force. In fact, the tensile force when the cable is pulled out will increase over the pulled-out length. However, in the case of only a relatively small increase in the spring characteristic, the user subjectively has the feeling that the tensile force to be applied is constant over the whole pulled-out distance. In this way, a high level of ease of use is provided to the user.

In an advantageous variant of the supply system according to the invention it can be provided that the at least one gas spring is fastened to the pulley block carrier on the one hand and is in operative connection with a counter bearing on the other hand. A housing of the supply system can act as counter bearing, for example. However, in principle other fastening possibilities or attachment points that are fixed in position are also suitable as counter bearing.

Alternatively, it can be provided that the gas spring is fastened in such a way that the pulley block carrier acts axially directly on the piston rod with a limit stop when it is displaced.

The supply system according to the invention preferably comprises at least one cord that acts on the piston rod of the gas spring and is connected to the housing and which acts on the piston rod of the gas spring through a displacement of the pulley block carrier. This cord is expediently formed as a high-tensile cord which has no spring-elastic properties. This variant of the supply system has the advantage that the gas spring can be fastened to the pulley block carrier and can form a compact structural unit with it.

To guarantee an easy and tilt-free guidance of the pulley block carrier formed as a carriage, it is advantageous if two gas springs are fastened to the pulley block carrier in such a way that a symmetrical spring-loading and/or damping of the pulley block carrier is guaranteed. The gas springs can each be fastened to a lateral side piece of the pulley block carrier, for example.

A particularly beneficial and low-friction, as well as anti-twist and anti-tilt guidance of the pulley block carrier inside the housing results if the pulley block carrier is supported against a guide profile or against an inside of the housing via a plurality of guide rollers. The carriage or pulley block carrier is thus preferably not mounted sliding but is mounted rolling.

A particularly smooth guidance is achieved if the guide rollers are ball bearing mounted. The ball bearings can be formed as grooved ball bearings, for example, which comprise a cage made of a thermoplastic. Such polymer bearings are corrosion-free as well as media- and temperature-resistant, and enable maintenance-free, low-friction and hygienic dry running. Alternatively, the guide rollers can be mounted on self-lubricating slide bearings made of a thermoplastic.

A cylinder is furthermore preferably fastened to the at least one gas spring on the pulley block carrier and the piston rod of the at least one gas spring engages, with a first deflection roller, in a loop of the cord in such a way that, when the pulley block carrier is displaced against the effective direction of the weight force, a piston of the at least one gas spring is slid inside the cylinder, compressing and/or displacing a gas volume.

It is particularly advantageous if the cord is fastened, at its ends, to the pulley block carrier and/or to the gas spring and is guided over a second deflection roller fixed in position, preferably in the housing. This arrangement guarantees that the distance between the two deflection points or deflection rollers remains the same when the gas spring is compressed and in the process the cord remains stretched.

### GENERAL

The supply system has, as a function, the automatic returning or retracting of the guided line and in this respect can also be called a return system. It preferably provides that the length of cable that can be pulled out is at least 2 metres, but preferably at least 3 metres.

In principle, the supply system is claimed without a cable but can particularly advantageously be used in combination with a cable, in particular a cable for charging electric vehicles. Cables which come into consideration as cables for charging electric vehicles, e.g. with a purely electric drive (battery electric vehicles) or with a partially electric drive (plug-in hybrid vehicles), are in particular cables suitable for this according to the usual standard. These cables are, e.g. in Europe, often designed with a connector according to the standard IEC 62196 or as a so-called Type 2 connector or e.g. as a so-called Combo 2 connector or coupling for direct current charging with up to 240 kW at 200-600 V direct voltage and up to 400 A direct current. In addition, there are further standards for plug connectors and charging cables. The charging cable is designed for a correspondingly typical load, in any case of at least 10 kW, and preferably has a corresponding charging plug for an electric vehicle, in particular a charging plug according to the standard IEC 62196-1 (2016) or standard IEC 62196-2 (2016) (e.g. Type 1/Type 2/Type 3), at the end which can be pulled out.

Since the charging cable has to carry a high electrical power typically of at least 11 kW, usually at least 22 kW, corresponding core cross sections (e.g. typically 5 G 6 mm²), core insulation as well as a sheath with the necessary mechanical protection are required. This makes such a charging cable, with a typical total cable cross section ≥15 mm, correspondingly heavy and stiff, with the result that it requires effort to wind up by hand. Here, the invention in all its aspects, in particular for or with charging cables of this type, makes the handling much easier for the user and also simplifies and reduces the cost of producing a charging column or charging station.

### BRIEF DESCRIPTION OF THE DRAWINGS

The invention is explained below, without limitation, with reference to and on the basis of the embodiment examples represented in the accompanying drawings.

There are shown in:

FIG. 1 is a front view of a first embodiment example of the supply system according to the invention;

FIG. 2 is a perspective view of the supply system according to FIG. 1;

FIG. 3 is a perspective back view of the supply system according to FIG. 1;

FIG. 4A is a cross section through the supply system according to the first embodiment example of the invention;

FIG. 4B is a perspective view of the pulley block carrier from FIG. 4A;

FIG. 5 is a perspective view of a supply system according to a second embodiment example of the invention;

FIG. 6 is a perspective view of the supply system according to FIG. 5 with the housing open;

FIG. 7 is a longitudinal section through the housing of the supply system according to the second embodiment example of the invention;

FIG. 8 is a perspective view of the supply system according to FIG. 5 without housing;

FIG. 9 is a perspective view of the supply system according to a third embodiment example of the invention with the housing open;

FIG. 10 is a perspective view of the supply system according to the third embodiment example of the invention without the housing;

FIGS. 11A-11D are representations of a particularly preferred fourth embodiment example of the supply system according to a further third aspect of the invention as a line retracting system in a retracted state of the cable, respectively in a front view (FIG. 11A) and in a side view (FIG. 11B), as well as in the pulled-out state of the cable, respectively in a front view (FIG. 11C) and in a side view (FIG. 11D) of the line retracting system;

FIGS. 12A-12C are views of the pulley cage or pulley block with pulleys distributed in the shape of a circular arc, in the closed state of the pulley cage (FIG. 12A), in the open state of the pulley cage in perspective (FIG. 12B) and in a side view (FIG. 12C); and

FIG. 13 is a front sectional view through a support profile to illustrate the advantageous multiple deflection of the retraction cords (expander cords), to achieve a uniform retraction force, according to a principle similar to FIGS. 1-3.

### DETAILED DESCRIPTION

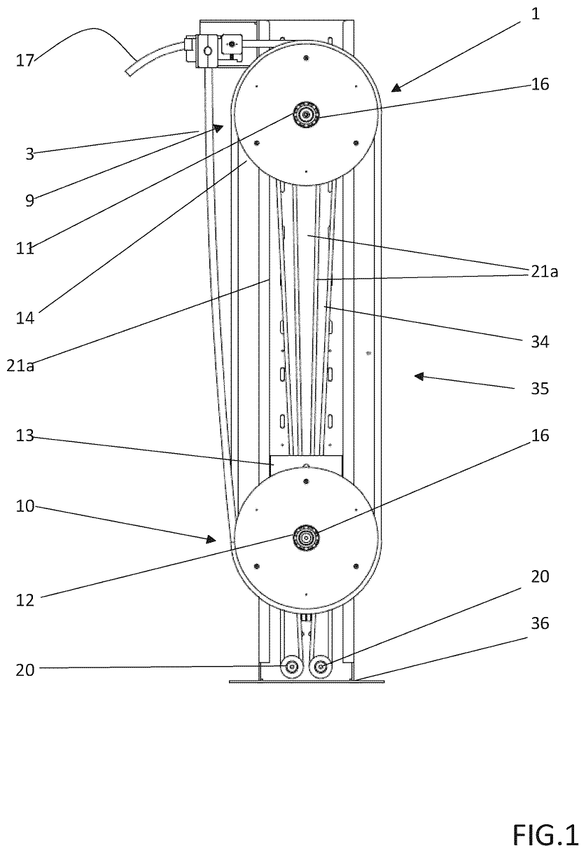

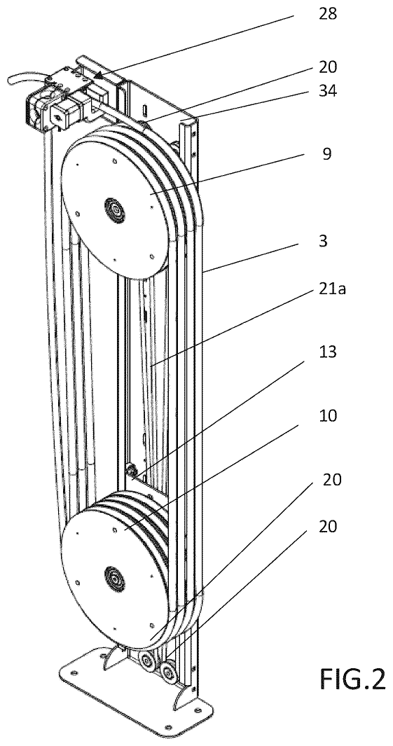

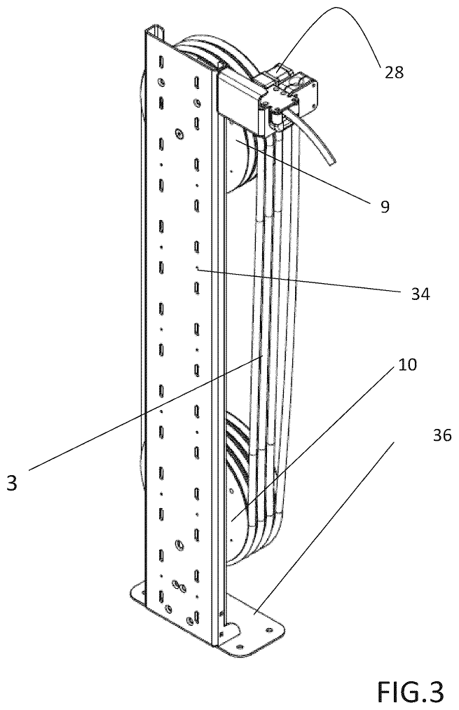

Reference is first of all made to FIGS. 1 to 4B, which show a first embodiment example according to the invention. In the embodiment examples described below, identical or functionally identical component parts are labelled with identical reference numbers.

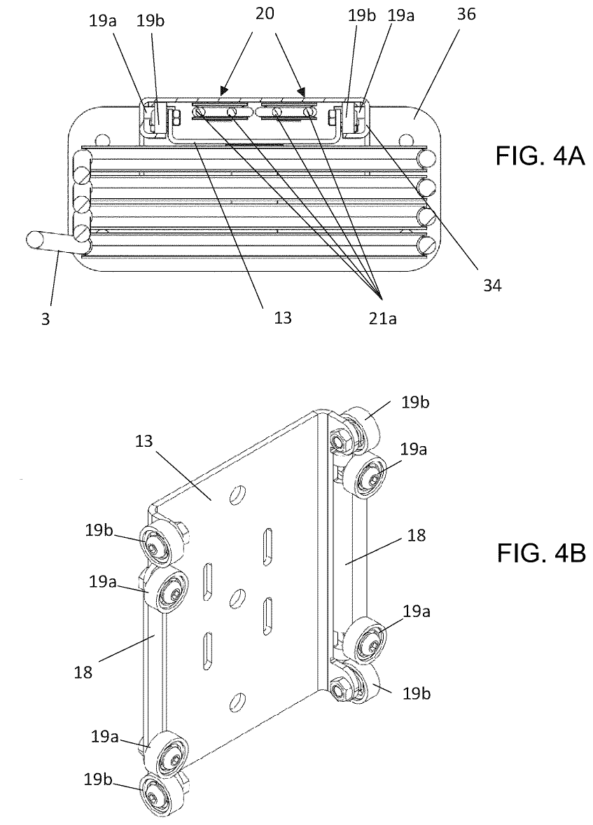

The supply system 1 comprises a cable store for a cable 3 as charging cable for an electric vehicle. The cable store of the supply system 1 comprises a first, upper pulley block 9 arranged fixed in position and a second, lower pulley block 10 displaceable relative thereto. The first pulley block 9 is mounted on a first axle 11, which is fastened cantilevered to a guide profile 34 of a frame 35, whereas the second pulley block 10 is mounted on a second axle 12, which is fastened cantilevered on a pulley block carrier 13, which is displaceable guided on the guide profile 34. As can be seen from FIGS. 4A and 4B, the guide profile 34 is formed as a profile rail which is formed with a C-shaped cross section, and which is supported against and fastened to the ground by means of a footplate 36. The pulley block carrier 13 to which the displaceable pulley block 10 is fastened is arranged slidingly displaceable inside the guide profile 34, with the result that the pulley blocks 9, 10 are movable towards each other and away from each other.

The pulley blocks 9, 10 each comprise four pulleys 14 mounted individually rotatable independently, which in turn are made up of individual pulley wheels 15. The pulleys 14 are mounted in each case on ball bearings 16, which are seated on the axles 11, 12.

The pulley blocks 9, 10 form a block and tackle with the cable 3 laid and reeved, in multiple windings, on them, wherein a pull on the free end 17 of the cable 3 (for reasons of simplification a connector is not represented) pulls the cable 3 out in such a way that the pulley block carrier 13 is lifted towards the first pulley block 9, wherein the cable portions located between the pulley blocks 9, 10 shorten and the pulled-out length of the cable 3 increases. The distance by which the cable 3 can be pulled out is naturally a multiple of the spacing of the pulley blocks 9, 10 from each other, wherein the force to be applied in the process is a fraction of the force which acts on each individual portion of the cable 3.

The pulley block carrier 13 is formed as a holding plate with a U-shaped profile in cross section, to the side pieces 18 of which guide rollers 19a, 19b, which are guided inside the guide profile 34 between guide bars and the back wall of the guide profile 34, are fastened. In the example according to FIGS. 1 to 4B, as FIG. 4B shows, in each case two groups with four guide rollers 19a, 19b are provided, which are supported in two perpendicular directions against tilting on the inside of the guide profile 34. The guide rollers 19a support against tilting about the axis of rotation of the pulley block 10, and the guide rollers 19b support against tilting about a horizontal axis perpendicular to the axis of rotation. Instead of a guidance with rollers which engage on the inside of the guide profile 34, a reverse arrangement is also possible, with a guidance on the outside of a corresponding profile. However, the guidance on the inside provides better protection of the guidance.

The pulley block carrier 13 is displaceable against the spring force of two expander cords 21a towards the upper first pulley block 9 that is fixed in position. The expander cords 21a are fastened to the back of the pulley block carrier 13 on the one hand and to the guide profile 34 on the other hand. Two deflection rollers 20 for the expander cords 21a are arranged in each case at the upper and at the lower end of the guide profile 34. The expander cords 21a, as spring elements which generate a restoring force for the pulley block carrier 13, are guided in each case at the top and bottom over the deflection rollers in multiple parallel portions.

The pulley block carrier 13 is displaced towards the first, upper pulley block 9 against the spring force of the expander cords 21a, which generate a restoring force that increases in proportion to the pulled-out length of the cable. Due to the fact that in each case an expander cord 21a is guided over an upper and a lower deflection roller 20, it is possible to provide relatively long spring elements with a relatively small spring constant in a space-saving manner. The spring characteristic resulting from this is relatively flat and gives the user the feeling that they can pull the cable 3 out of the cable store with almost constant force.

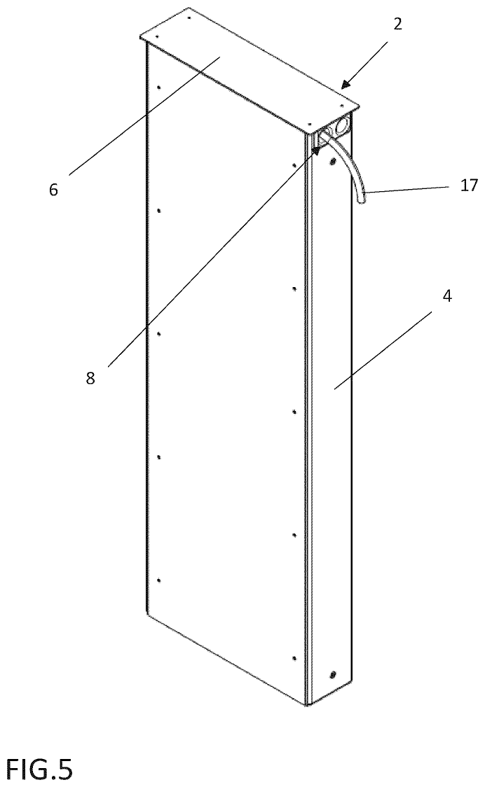

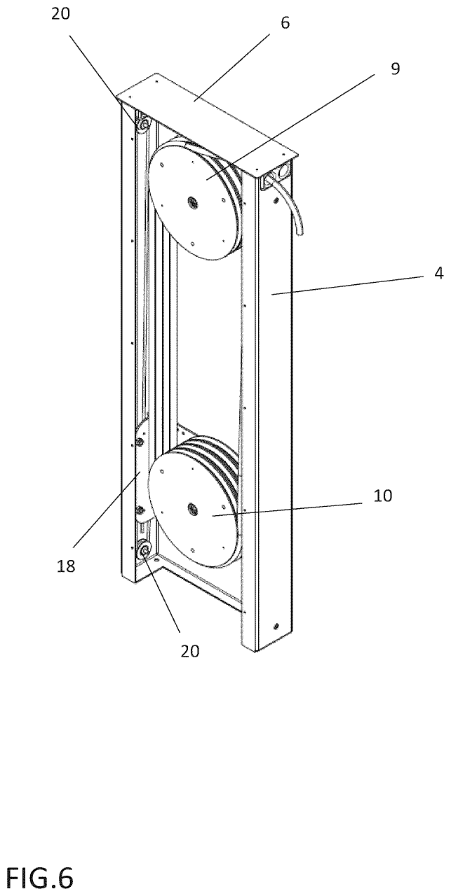

The supply system 1 according to a second and third embodiment example of the invention represented in FIGS. 5 to 10 comprises a cuboid housing 2, which is made up of several housing parts. The housing 2 accommodates a cable store for a charging cable which functions approximately corresponding to the first embodiment example.

Of course, the invention is to be understood such that the type of cable is not important for the supply system 1.

The housing 2 substantially comprises two face profiles 4 formed as feet, two side parts 5, only one of which is represented in the figures, as well as an upper housing cover 6. The housing 2 furthermore comprises a cable entry 7 at the bottom of a face profile 4 and a cable exit 8 on its front side.

The cable store arranged inside the housing 2 comprises a first, upper pulley block 9 arranged fixed in position and a second, lower pulley block 10 displaceable relative thereto. The first pulley block 9 is mounted on a first axle 11, which is fastened cantilevered to a side part 5 of the housing 2, whereas the second pulley block 10 is mounted on a second axle 12, which is fastened cantilevered on a pulley block carrier 13 formed as a carriage, which is displaceable guided inside the housing 2. The pulley blocks 9, 10 each comprise four pulleys 14 mounted individually rotatable independently, which in turn are made up of individual pulley wheels 15. The pulleys 14 are mounted in each case on ball bearings 16, which are seated on the axles 11, 12.

The pulley blocks 9, 10 form a block and tackle with the cable 3 laid and reeved, in multiple windings, on them, wherein a pull on the free end 17 of the cable 3 (in this embodiment example a connector is likewise not represented for reasons of simplification) pulls the cable 3 out in such a way that the pulley block carrier 13 is lifted towards the first pulley block 9, wherein the cable portions extending between the pulley blocks 9, 10 shorten and the pulled-out length of the cable 3 increases. The distance by which the cable 3 can be pulled out is a multiple of the spacing of the pulley blocks 9, 10 from each other, wherein the force to be applied in the process is a fraction of the force which acts on each individual portion of the cable 3.

As in the case of the supply system 1 of the first embodiment example, the first axle 11 and the second axle 12 are each fastened on one side and arranged cantilevered. The second axle 12 of the second pulley block 10 is fastened on the pulley block carrier 13 which is formed as a profile with a C-shaped cross section, and which has lateral side pieces 18 which are guided in an anti-twist and anti-tilt manner inside the face profiles 4 of the housing 2. In each case six guide rollers 19a, 19b, namely a pair of first guide rollers 19a and four second guide rollers 19b, which bring about a guidance of the pulley block carrier 13 inside the face profiles 4 of the housing 2 in two possible degrees of freedom perpendicular to each other, are arranged on each side piece 18 of the pulley block carrier 13, wherein on each side of the pulley block carrier 13 in each case two guide rollers 19a are supported on a front face of a face profile 4 and in each case four guide rollers 19b are supported against side surfaces of a face profile 4.

In the following, reference is made first of all to the second embodiment example according to FIGS. 5 to 8, in which, just as in the embodiment example according to FIGS. 1 to 4B, a restoring force is generated for the pulley block carrier 13 by means of expander cords 21a.

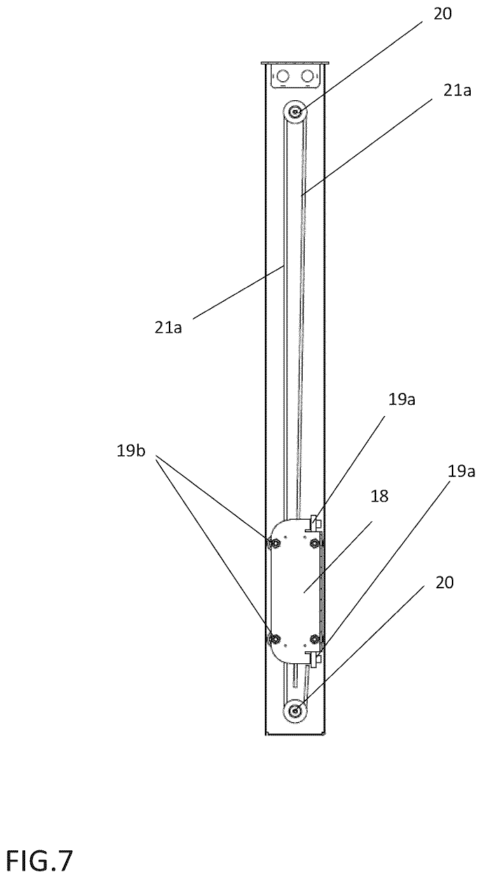

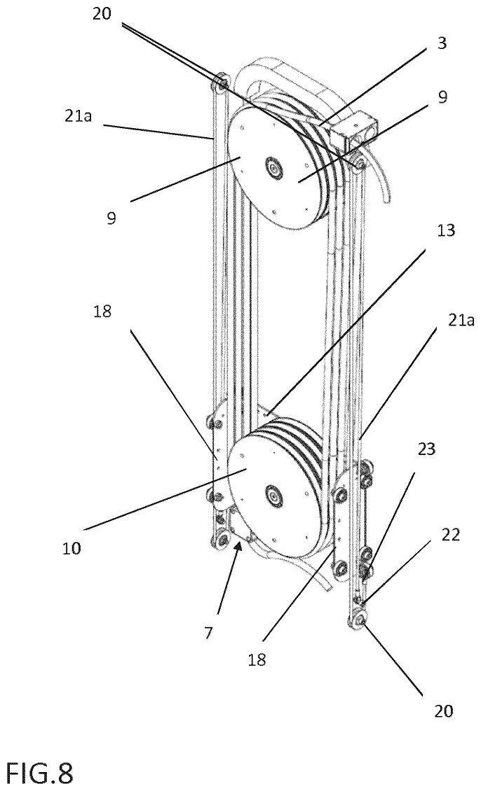

As the representation in FIG. 7 shows in particular, on the inside of the face profiles 4 of the housing 2 in each case deflection rollers 20 are arranged, over which an expander cord 21a is guided as spring element. The expander cord 21a is fastened to a face profile 4 of the housing 2 by means of a first fastening clamp (see FIG. 8) at a first fastening point 22 and, after being deflected twice around an upper and a lower deflection roller 20, fastened to a side piece 18 of the pulley block carrier 13 with a second fastening clamp at a second fastening point 23. A displacement of the pulley block carrier 13 towards the first, upper pulley block 9 is effected against the spring force of the expander cord 21a, which generates a restoring force that increases in proportion to the pulled-out length of the cable.

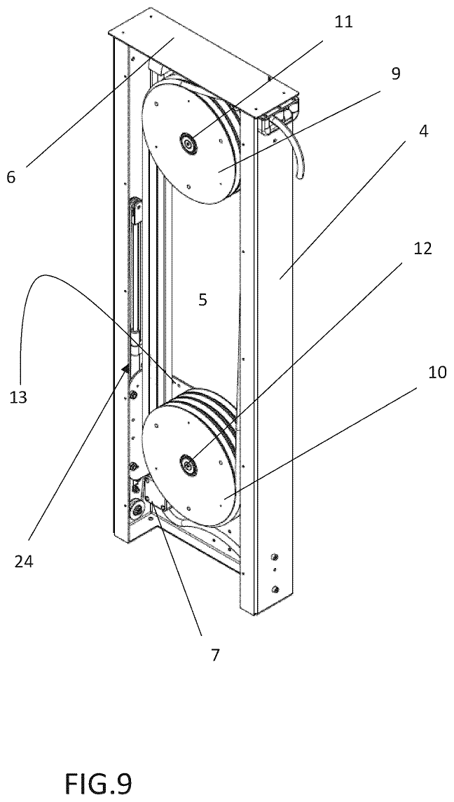

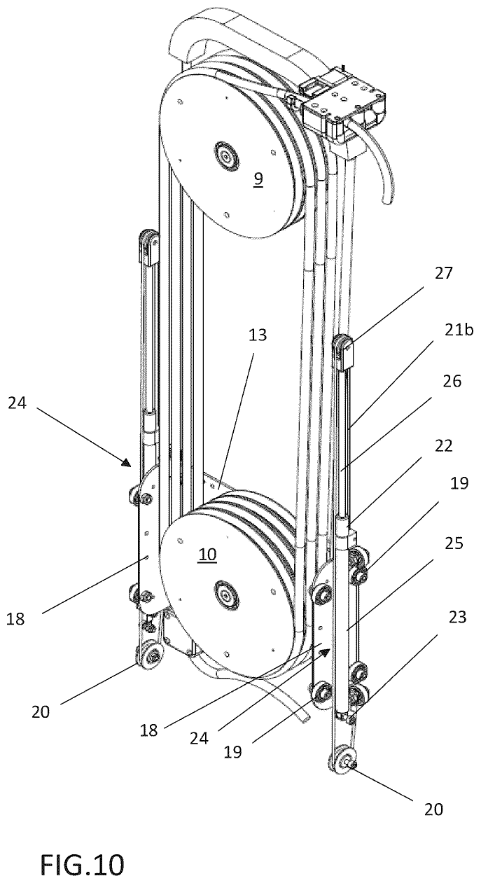

In the following, the third embodiment example according to the invention is explained with reference to FIGS. 9 and 10. Just like the supply system 1 according to the second embodiment example of the invention, the supply system 1 according to the third embodiment example of the invention comprises a housing 2 which is formed approximately corresponding to the housing according to the second embodiment example of the invention. The restoring force for the pulley block carrier 13 according to the supply system 1 of the third embodiment example is, however, as described below, generated by means of gas springs 24.

A gas spring 24, which comprises a gas-filled cylinder 25 as well as a piston rod 26 slidable in the cylinder 25, is provided on each of the lateral side pieces 18 of the pulley block carrier 13. The gas springs 24 are installed on the pulley block carrier 13 such that the piston rods 26 each point upwards in the installed position and are compressed against the movement direction of the second pulley block 10 and generate a predefined restoring force when the cable 3 is pulled out of the supply system 1.

The piston rod 26 comprises a piston that is slidably mounted in the cylinder 25 and sealed therein, and at its free end is provided with a deflection roller 27, which engages in a loop of a high-tensile and non-elastic cord 21b. The cord 21b is attached to the cylinder 25 of the gas spring 24 at a first fastening point 22 and to the lateral side piece 18 of the pulley block carrier 13 at a second fastening point 23. The cord 21b is deflected twice and guided from the second fastening point 23, over a deflection roller 20 fastened to the housing 2, in a loop over the deflection roller 27 at a leading end of the piston rod 26, to the second fastening point 23 on the cylinder 25 of the gas spring 24.

A pull on the cable 3 brings about a displacement of the second pulley block 10 towards the first pulley block 9 accompanied by partial unwinding of the cable 3 from the thus-formed cable store. In the process, the cord 21b, which is placed in the loop and fixed to the housing 2 over the deflection roller 20, brings about an actuation of the piston rod 26 in such a way that the gas spring 24 is compressed, i.e. the piston rod 26 dips into the cylinder 25. Due to the fact that cord 21b is fastened, at its ends, to the pulley block carrier 13 and to the gas spring 24, it is guaranteed that the distance between the two deflection points or deflection rollers 20, 27 remains the same when the gas spring 24 is compressed and the cord 21b does not sag during the compression.

A displacement of the pulley block carrier 13 towards the first, upper pulley block 9 is effected against the spring force of the gas springs 24, which generate a restoring force that increases in proportion to the pulled-out length of the cable. The spring characteristic resulting from this is relatively flat and gives the user the feeling that they can pull the cable 3 out of the housing 2 with almost constant force. In addition, the gas springs 24 achieve a damping of the retracting movement when the tension on the cable 3 is ceased and the cable 3 is wound up again.

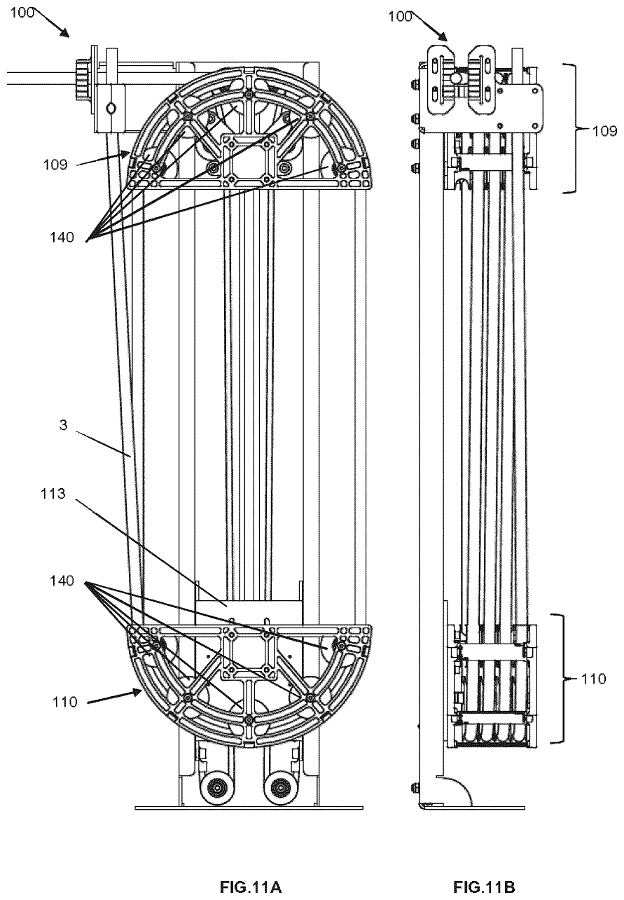

A further, particularly preferred embodiment example is described below with reference to FIGS. 11-13. Here, the important differences from previous examples are discussed for the sake of brevity. Already described features, some of which are labelled with reference numbers increased by one hundred and are recognizable from the figures, are not all explained again.

FIGS. 11-13 show a return system or supply system 100 for a Type 2 charging cable 3 for charging electric vehicles, with a cable store, which has a plurality of pulleys 140.

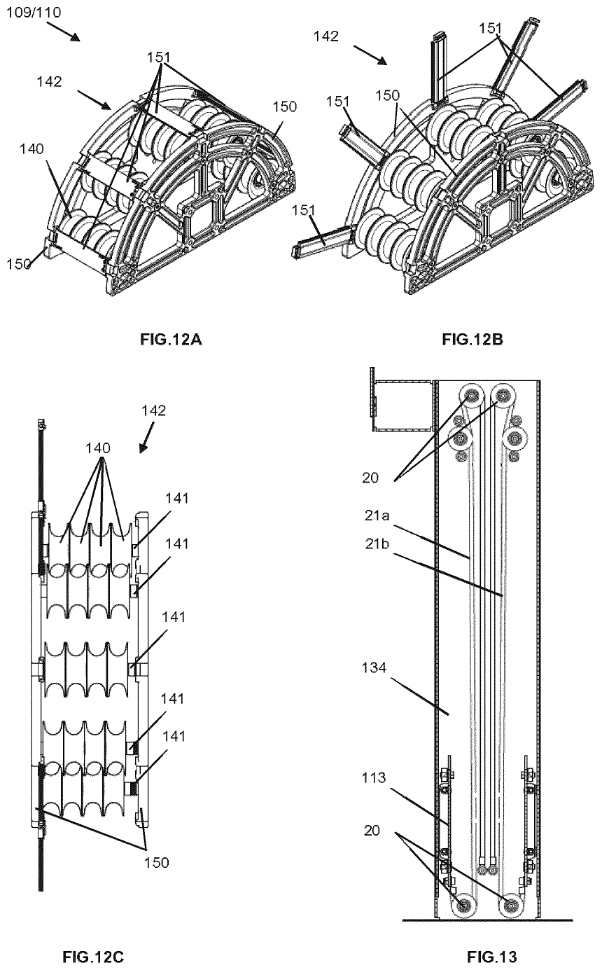

Here too, the pulleys are grouped in two pulley blocks 109, 110 and arranged such that the cable 3 can be reeved, in multiple windings (cf. FIGS. 11B/11D), in or laid on the pulley blocks 109, 110. Here too, a first pulley block 109 is attached fixed in position, e.g. screwed to a central support and guide profile 134 (cf. FIG. 11B). The second pulley block 110 is mounted vertically slidable relative to the first pulley block 109. As shown in FIG. 13, the second pulley block 110 is adjustable or movable vertically up and down here by means of a carriage or carriage-like pulley block carrier 113, which is guided by means of a suitable roller bearing—e.g. analogously to FIGS. 4A-4B—on the support and guide profile 134.

In FIGS. 11-13, the pulley block carrier 113 is also movable against a restoring force, which is generated by two elastic expander cords 21a, 21b deflected multiple times, as can be seen in FIG. 13. Each of the expander cords 21a, 21b is placed in each case, in at least one loop, over two deflection rollers 20 (cf. FIG. 13) that are spaced apart from each other in the guide direction, with the result that each expander cord 21a, 21b in each case forms two portions of a loop, which run along the guide direction, here substantially vertically, before the expander cord 21a, 21b engages on the carriage or pulley block carrier 113. This multiple deflection of the expander cords 21a, 21b, here over deflection rollers 20 mounted at the ends of the support and guide profile 134, here also ensures a uniform retraction force with a small increase in the spring characteristic, with the result that the spring force only increases slightly when the cable 3 is pulled out. At the other end, the expander cords 21a, 21b are fastened to the support and guide profile 134 close to the lower deflection rollers 20, with the result that the loops are extended over 80% of the length of the guide profile 134, and the expander cords 21a, 21b already have a length of approximately, or more than, double the overall length of the guide profile 134 even in the fully retracted state.

An important difference and advantage of the construction of the fourth embodiment example in FIGS. 11-13 is that at least one of the two pulley blocks 109, 110, in the example shown each of the two pulley blocks 109, 110, in each case has multiple pulleys 140 arranged distributed in an arc shape over a circular arc around a deflection axis, wherein in each case pulley groups with multiple pulleys 140, here four pulleys, are arranged distributed in an arc shape over a circular arc. The second pulley block 110 including all of its pulleys 140 arranged distributed over a circular arc is arranged on the linearly guided, displaceable pulley block carrier 113 and adjustable therewith.

As FIG. 11A and FIG. 11C show, in each of the two pulley blocks 109, 110, the pulley groups or pulleys 140 are distributed over a circular arc the arc measure of which is slightly smaller than 180°. In each of the two pulley blocks 109, 110 at least four, here five, pulley groups are uniformly distributed around an imaginary deflection axis, which is perpendicular to the guide plane which defines the guide profile 134 for the pulley block carrier 113, see FIG. 11A and FIG. 11C.

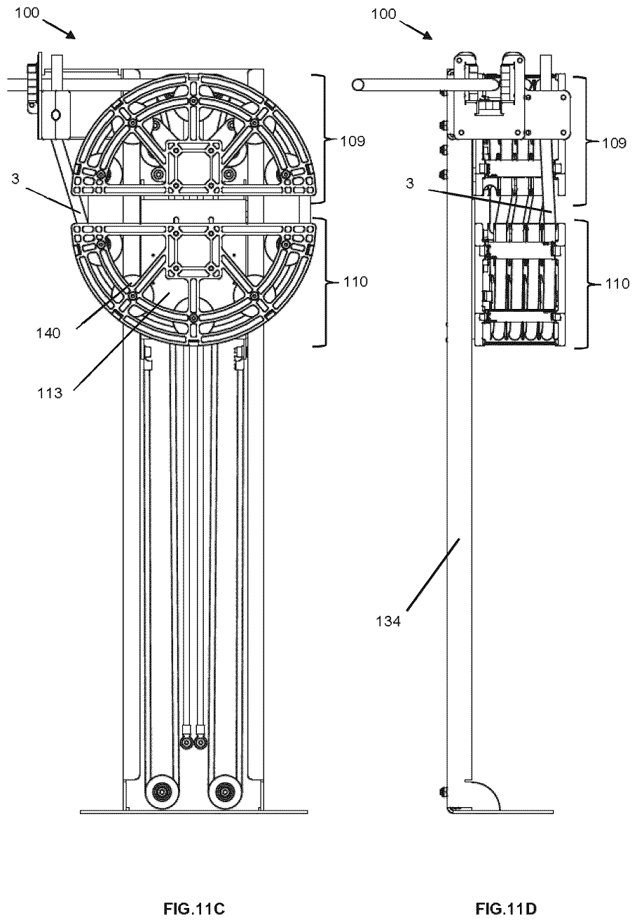

As can be seen from also looking at FIGS. 12A-12C, each of the two substantially structurally identically designed pulley blocks 109, 110 has a substantially semicircular frame 142 with axles 141 distributed over the circular arc. As FIG. 12C shows best, each axle 141 bears in each case four coaxial pulleys 140.

All pulleys 140 are preferably cable-protecting plastic pulleys with an approximately semicircular cross-sectional profile for holding and guiding the cable 3 (cf. FIG. 12C), which is designed for cables with a cable diameter of at least 12 mm. The axles 141 of the pulley groups are each held on and fastened to two axially opposite, structurally identical carrier elements 150, which define or predefine the circular arc for the distributed axles 141 and can be manufactured as light injection-moulded plastic parts, in a framework construction.

FIG. 12C furthermore shows that successive pulleys 140 in the arc direction are mounted axially offset with respect to each other on the axles 141, with the result that an offset of the cable 3 during the transition from one pulley block 109, 110 to the other is reduced or minimized, on this see FIG. 11D. Each pulley block is positioned offset by a few millimetres with respect to the next, such that the cable 3 needs to overcome no or only a very small offset at the transition from one pulley block 109, 110 to the other.

As FIGS. 12A-12C show, each frame 142 is designed such that it forms a pulley cage for securely holding the windings of the cable 3 on the pulleys 140. For this, each pulley block 109, 110 has, arranged radially outwardly offset with respect to the axles 141 of the distributed pulleys 140, securing bars 151 likewise distributed in a circular arc shape. The securing bars 151 are held on one or both carrier elements 150 so as to be able to fold out or swivel open (shown open in FIGS. 12B-12C) and, in the closed state, hold the cable firmly on the pulley block 109, 110, as can be seen in FIG. 12A and FIG. 11D, with the result that it cannot jump off, even if it is pushed in by the user without a movement of the second pulley block 110.

The pulley cages with the pulley block 109, 110 have multiple functions: they serve to guide the line or the cable 3 and, in contrast to complete pulleys (cf. FIGS. 1-3), the pulley cage makes it possible that the two pulley blocks 109, 110, with their imaginary deflection axes of the windings (cf. axes of the circular arc shape of the carrier elements 150), can move very close to each other. The necessary line length for the retracting function is thus shortened, or less cable length is required. The fold-out securing bars 151 protect against the cable “jumping off” in an undesired manner. Due to the multiple deflection, long pulled-out lengths of the cable are possible, with a small installation space of the system.

The construction, in combination with the central guide rail 134 and the implementation of the pulley blocks 109, 110 mounted only on one side or cantilevered, analogously to FIGS. 1-4B, guarantees that the system can be easily filled with the cable without it having to be threaded through laboriously.

Just like in FIGS. 1-4B, FIGS. 11B/11D show that the second pulley block 110 is held on the pulley block carrier 113 on one side and cantilevered with only one of the two carrier elements 150, and the first pulley block 109 is fastened to the guide rail 134 of the pulley block carrier 113 with only one of the two carrier elements 150, therefore likewise on one side and cantilevered.

Here, the guide rail 134 or the guide profile 134 has, as in relation to FIGS. 1-4B, a cross section which is substantially C-shaped with inwardly facing, wing regions that spring back opposite the main surface. The guide profile 134 can be manufactured in the manner of a carrier as a metal profile made of steel or aluminium and provides a robust, stable guidance for the mounting, on one side, of the carriage-like pulley block carrier 113 of the movable pulley block 110. An advantage of the guide profile 134 is that this construction can be used in a wide variety of housings or also without a housing.

Accordingly, a solution for the automatic rewinding of a cable 3 is proposed herein. This prevents hazards and line damage due to incorrect winding or cables 3 lying on the ground. The system 10, 100 is used in applications where a mobile terminal is connected to a cable 3 and until now was only rolled up by hand, in particular in the case of a charging station or a wall box for an electric car. A slip ring is dispensed with entirely.

List of reference numbers
FIGS. 1-10

| | |
|---|---|
| 1 | supply system |
| 2 | housing |
| 3 | cable |
| 4 | face profiles |
| 5 | side parts |
| 6 | housing cover |
| 7 | cable entry |
| 8 | cable exit |
| 9 | first pulley block |
| 10 | second pulley block |
| 11 | first axle |
| 12 | second axle |
| 13 | pulley block carrier |
| 14 | pulleys |
| 15 | pulley wheels |
| 16 | ball bearing |
| 17 | free end of the cable |
| 18 | side piece of the pulley block carrier |
| 19a | first guide rollers |
| 19b | second guide rollers |
| 20 | deflection rollers |
| 21a | expander cord |
| 21b | (high-tensile) cord |
| 22 | first fastening point |
| 23 | second fastening point |
| 24 | gas spring |
| 25 | cylinder |
| 26 | piston rod |
| 27 | deflection roller |
| 28 | pull-out and removal prevention device |
| 29 | cable guide module |
| 30 | cable lead-through |
| 31 | clamping shoe |
| 32 | spindle drive |
| 33 | servomotor |
| 34 | guide profile |
| 35 | frame |
| 36 | footplate |
| 37 | small rollers |

FIGS. 11A-11B, FIGS. 12A-12C, FIG. 13

| | |
|---|---|
| 3 | charging cable (Type 2) |
| 20 | deflection roller |
| 21a, 21b | expander cords |
| 100 | supply system |
| 109 | first pulley block |
| 110 | second pulley block |
| 113 | pulley block carrier |
| 134 | support and guide profile |
| 140 | pulleys |
| 141 | pulley axle |
| 142 | semicircular frame |
| 150 | carrier element |
| 151 | securing bar (fold-out) |

What is claimed is:

1-22. (canceled)

23. A supply system for an electrical line, in particular for a cable for charging electric vehicles, comprising at least one cable store, wherein the cable store comprises a plurality of pulleys, which are arranged in at least two pulley blocks such that a cable can be reeved into the pulley blocks in multiple windings, wherein a first pulley block and a second pulley block are displaceable relative to each other, at least one of the first and second pulley blocks is arranged on a linearly guided, displaceable pulley block carrier, and the first and the second pulley block are movable towards each other against a restoring force,
wherein the pulley blocks each have at least one axle for the rotatable mounting of the pulleys, wherein the first and the second pulley block are mounted on one side and cantilevered or self-supporting with their respective axles such that the pulley blocks are accessible on one side in such a way that a cable can be laid from one side, wherein the pulley block carrier is guided on or in at least one centrally arranged guide profile, which is formed as a guide frame or guide rail which has a C- or U-shaped cross-sectional profile, which is open in the direction of the extent of an axle, wherein the second pulley block is mounted on one side and cantilevered on at least one axle, which is fastened to a pulley block carrier formed as a carriage, wherein the pulley block carrier is supported on the guide profile via guide rollers and/or via sliding guides.

24. The supply system for an electrical line according to claim 23, wherein the first pulley block is arranged fixed in position and wherein the second pulley block is displaceable with respect to the first pulley block on the pulley block carrier.

25. The supply system for an electrical line according to claim 23, wherein at least one pulley block has in each case multiple pulleys arranged distributed in an arc shape over a circular arc around a deflection axis and at least one of the first and second pulley blocks is arranged and held on a linearly guided, displaceable pulley block carrier.

26. The supply system for an electrical line according to claim 23, wherein the pulley blocks are arranged in a housing.

27. A supply system for an electrical line, in particular for a cable for charging electric vehicles, comprising at least one cable store, wherein the cable store comprises a plurality of pulleys, which are arranged in at least two pulley blocks such that a cable can be reeved into the pulley blocks in multiple windings, wherein a first pulley block and a second pulley block are displaceable relative to each other, at least one of the first and second pulley blocks is arranged on a pulley block carrier linearly guided in or on a guide profile and displaceable along a guide direction and the first and the second pulley block are movable towards each other against a restoring force,
wherein the restoring force is generated, as a spring force, by means of at least one elongate spring element, which acts to exert the restoring force on the second pulley block and extends in at least two portions over at least one deflection point, wherein the spring element or expander cord is guided over at least two deflection rollers spaced apart from each other in the guide direction, with two portions of the loop which run along the guide direction and wherein the spring force is generated by means of two spring elements and wherein in each case one spring element is fixed to the pulley block carrier, wherein the spring elements are preferably guided separately, in particular in each case over two deflection rollers spaced apart from each other in the guide direction, in each case with two portions of the loop which run along the guide direction.

28. The supply system for an electrical line according to claim 27, wherein the second pulley block is carried by a pulley block carrier or carriage that is linearly guided, in particular in a rolling or sliding manner, and the spring force is generated by means of two elongate, flexible spring elements and wherein in each case one spring element is fixed to one of two opposite sides of the second pulley block, in particular of the pulley block carrier or carriage.

29. The supply system for an electrical line according to claim 27, wherein each of the spring elements is guided over at least one first and one second deflection roller, preferably over at least one upper and lower deflection roller, which are provided, in particular fixed in position, in each case in one of the two end regions of the guide direction of the pulley block carrier.

30. The supply system for an electrical line according to claim 29, wherein the first and/or second deflection roller is or are attached fixed in position, in particular to a housing in which the pulley blocks are accommodated and/or to a guide profile on which the pulley block carrier is guided.

31. A supply system for an electrical line, in particular for a cable for charging electric vehicles, comprising at least one cable store, wherein the cable store comprises a plurality of pulleys, which are arranged in at least two pulley blocks such that a cable can be reeved into the pulley blocks in multiple windings, wherein a first pulley block and a second pulley block are displaceable relative to each other and movable towards each other against a restoring force,
wherein at least one of the two pulley blocks, preferably each of the two pulley blocks, has in each case multiple pulleys arranged distributed in an arc shape over a circular arc around a deflection axis, and
wherein at least one of the first and second pulley blocks is arranged and held on a linearly guided, displaceable pulley block carrier, wherein successive pulleys in the arc direction are mounted axially offset with respect to each other, with the result that an offset of the cable during the transition from one pulley block to the other is reduced or minimized and the pulleys are plastic pulleys with a line-protecting guide cross section, in particular for cables with a cable cross section ≥15 mm.

32. The supply system for an electrical line according to claim 31, wherein, in the case of each of the two pulley blocks, the pulleys are distributed over a circular arc the arc measure of which is ≤180° and/or at least four pulley groups arranged distributed are provided.

33. The supply system for an electrical line according to claim 31, wherein each of the two pulley blocks has a substantially semicircular frame with axles distributed over the circular arc, which bear in each case at least one pulley, preferably in each case at least two, and two axially opposite carrier elements on which the axles are held.

34. The supply system for an electrical line according to claim 31, wherein, on the outside compared with the distributed pulleys, each pulley block has securing bars, which are preferably arranged distributed in an arc shape and which act against a radial releasing of the cable from the respective pulley block, wherein the securing bars are preferably releasably attached to the frame, in particular to the carrier elements, in particular so as to be able to fold out, and/or wherein the securing bars preferably form a pulley cage with the frame for securely holding the cable.

35. The supply system for an electrical line according to claim 31, wherein the first pulley block is arranged fixed in position and wherein the second pulley block is displaceable with respect to the first pulley block on a linearly guided or movable pulley block carrier.

36. The supply system for an electrical line according to claim 35, wherein the pulley block carrier is guided on or in at least one guide profile, which is formed as a guide frame or guide rail.

37. The supply system according to claim 31, wherein the second pulley block is fastened on one side and cantilevered, in particular to the pulley block carrier, and wherein the first pulley block is fastened on one side and cantilevered, in particular to a housing or a guide rail of the pulley block carrier.
